(19) United States
(12) Patent Application Publication
(10) Pub. No.: US 2020/0340407 A1
(43) Pub. Date: Oct. 29, 2020

(54) PRESSURE RELIEF DEVICE HAVING A PRESSURE RELIEF FLAP

(71) Applicant: Rolls-Royce Deutschland Ltd & Co KG, Blankenfelde-Mahlow (DE)

(72) Inventor: Predrag Todorovic, Berlin (DE)

(21) Appl. No.: 16/845,764

(22) Filed: Apr. 10, 2020

(30) Foreign Application Priority Data
Apr. 25, 2019 (DE) 10 2019 110 693.1

(51) Int. Cl. F02C 9/18

(52) U.S. Cl. CPC F02C 9/18; F05D 2220/323

(57) ABSTRACT

A pressure-release device has a pressure-release flap arranged in a delimiting wall of a chamber of an aircraft engine which opens in the presence of a predefined pressure in the chamber. The pressure-release flap includes a flap region and a hinge. The flap region is defined by a perforation formed in the delimiting wall which delimits the flap region with respect to a surrounding region of the delimiting wall. The perforation is formed such that, in the presence of the predefined pressure in the chamber, the flap region pivots open relative to the surrounding region, with the perforation rupturing, and the hinge is fixedly connected to the surrounding region and the flap region, such that the hinge holds the flap region on the surrounding region in the event of a rupture of the perforation and a pivoting-open of the flap region.

This application claims priority to German Patent Application DE102019110693.1 filed Apr. 25, 2019, the entirety of which is incorporated by reference herein.

The invention relates to a pressure-release device having a pressure-release flap as per the preamble of Patent Claim 1.

It is known for pressure-release flaps to be arranged in an aircraft engine or in an auxiliary engine, wherein both types of engine will hereinafter be referred to as aircraft engine. Such pressure-release flaps are arranged in the wall of a chamber of the engine and are designed to automatically open if the internal pressure in the chamber exceeds a predefined value. Such a pressure increase may arise for example in the event of a breakage of a line which transports compressed air and which is arranged in the chamber or which is connected in terms of flow to the chamber. Pressure-release flaps are typically formed inter alia in the outer wall of the nacelle of an aircraft engine.

In order to ensure an opening of a pressure-release flap in the presence of a defined pressure, numerous pressure-sensitive locking mechanisms are known which are however of relatively complex construction.

It is known from EP 3 382 161 A1 to provide, in a pressure-release flap, a multiplicity of lugs which bend outward in the presence of a particular internal pressure.

The invention is based on the object of providing a pressure-release device which, in a simple and effective manner, permits the opening of a pressure-release flap in the event of a defined internal pressure being attained.

This object is achieved by means of a device having the features of Patent Claim 1. Refinements of the invention are indicated in the dependent claims.

According to said claim, the invention relates to a pressure-release device having a pressure-release flap which is arranged in a delimiting wall of a chamber of an aircraft engine and which is designed to open in the presence of a predefined pressure in the chamber. Provision is made whereby the pressure-release flap comprises a flap region and a hinge. Here, the flap region is defined by a perforation which is formed in the delimiting wall and which delimits the flap region with respect to a surrounding region of the delimiting wall. The perforation is formed such that, in the presence of the predefined pressure in the chamber, the flap region pivots open relative to the surrounding region of the delimiting wall, with the perforation rupturing. The hinge is fixedly connected to the surrounding region of the delimiting wall and the flap region, such that the hinge holds the flap region on the surrounding region of the delimiting wall in the event of a rupture of the perforation and a pivoting-open of the flap region.

Accordingly, the invention is based on the concept of providing the flap region of a pressure-release flap by means of a perforation in the delimiting wall of the chamber in question, and, at the same time of ensuring, using a hinge, that the flap region remains securely on the delimiting wall, and does not break away, in the event of a rupture of the perforation.

The solution according to the invention is easily implementable because it is possible to dispense with separate locking or unlocking mechanisms for opening the pressure-release flap. Here, by means of the number and size of the openings of the perforation, with the knowledge of the material used and of the thickness of the delimiting wall, it is possible to positively define the internal pressure above which the perforation ruptures and the flap region of the pressure-release flap pivots open.

A further advantage associated with the invention consists in that the outer surface of the delimiting wall is substantially not impaired by the perforation that defines the flap region of the pressure-release flap. Thus, no elevations arise on the boundary wall as a result of the formation of the perforation. There is also no need to attach separate seal elements. In this way, an aerodynamic solution is provided which does not increase the flow resistance and which does not lead to additional turbulence.

It is pointed out that, in the context of the present invention, the expression “hinge” is to be understood in a purely functional sense, and in the sense that the flap region is pivotable relative to the surrounding region of the delimiting wall by means of the hinge, wherein the hinge simultaneously fixes the flap region to the surrounding region.

In one refinement of the invention, provision is made whereby the perforation comprises a multiplicity of holes which are arranged in a line and which extend all the way through the delimiting wall. The holes of the perforation thus do not merely weaken the material of the delimiting wall to a particular depth but rather extend all the way through said material. Alternatively, provision may be made whereby the holes of the perforation do not extend all the way through the delimiting wall.

In one refinement, the holes of the perforation all have the same size and the same spacing to one another, such that they can be produced in the same way. Alternatively, variations in size and spacing may be provided. The holes are produced for example by virtue of holes being drilled into the delimiting wall or already during the production of the delimiting wall.

In one design variant, the holes of the perforation have a diameter which lies in the range between 50 μm and 2 mm. As already stated, it is the case here in one design variant that all of the holes of the perforation have the same diameter.

In a further refinement of the invention, provision is made whereby the delimiting wall comprises multiple material layers. In this case, one design variant provides for the perforation to extend through all of the material layers.

The hinge may in principle be composed of any material which is suitable for connecting the flap region and the surrounding region and which simultaneously enables the flap region to pivot relative to the surrounding region. Design variants in this regard provide for the hinge to be composed of a different material than the delimiting wall. In this way, the material characteristics can be optimized in accordance with the desired functionalities of flap region and hinge.

A further refinement provides for the hinge to have at least one material ply which is of areal form and which is connected on the one hand to the flap region and on the other hand to the surrounding region. Here, the material ply is for example in the form of an elongate material strip, wherein the material strip is connected, along one longitudinal edge thereof and adjacent thereto, to the flap region and, along the other longitudinal edge thereof and adjacent thereto, to the surrounding region. Here, provision is furthermore made whereby the flap region and the surrounding region are rectilinearly adjacent to one another in the portion that is covered by the elongate material strip, such that mutual pivotability is realized.

One refinement of the invention provides for the hinge to have at least one material ply composed of a composite material, in particular a fiber composite material. In particular, one design variant of the invention provides for the hinge to have at least one material ply composed of an aramid-fiber-reinforced composite material, for example an aramid-fiber-reinforced plastic. In the case of the fiber-plastic composite in question, the fibers are thus composed of aramid, which is also known under the trade name Kevlar®. Such aramid-fiber-reinforced composite materials are highly deformable while simultaneously exhibiting high tensile strength and breaking strength, such that they do not break in the event of a pivoting-open of the flap region.

The delimiting wall including the flap region is formed for example by a carbon-fiber-reinforced plastic or a glass-fiber-reinforced plastic.

Here, one design variant provides a combination of a hinge composed of an aramid-fiber-reinforced composite material with a delimiting wall composed of a carbon-fiber-reinforced plastic or a glass-fiber-reinforced plastic. Here, a relatively lightweight and stable material for the delimiting wall is combined with a deformable material with relatively high tensile strength for the hinge.

Here, provision may be made whereby the material ply composed of an aramid-fiber-reinforced composite material and the delimiting wall composed of a carbon-fiber-reinforced plastic or a glass-fiber-reinforced plastic have been produced jointly during the course of the production of a multi-ply composite material, and have been cured simultaneously in a plastics matrix. However, this is not necessarily the case. Alternatively, provision may be made whereby the at least one material ply composed of an aramid-fiber-reinforced composite material has been produced separately and subsequently connected to the flap region and to the surrounding region of the delimiting wall.

A further refinement provides for the delimiting wall including the flap region to be formed by a metal or a metal alloy. For this case, the hinge may also be composed of a metal or of a metal alloy. In this case, the metal or the metal alloy of the hinge must exhibit sufficiently high ductility in order that it does not break during a pivoting-open of the flap region.

A further refinement of the invention provides for the perforation to also extend in that region of the delimiting wall in which the hinge is connected to the surrounding region of the delimiting wall and to the flap region, wherein the perforation is covered in this region by the hinge. The perforation is thus not interrupted in the region of the hinge, but rather forms a closed line and also runs in that region of the delimiting wall in which the hinge is arranged. This is associated with the advantage that the pivoting movement of the flap region relative to the surrounding region is defined exclusively or at least primarily by the hinge, without this pivoting movement being impeded to a greater extent by the material connection of the flap region to the surrounding region in the region of the hinge.

A further refinement provides for the hinge to be formed on the inner side of the delimiting wall. In this way, said hinge cannot generate a flow resistance on the outer side.

In one refinement of the invention, provision is made whereby the pressure-release flap has the shape of a polygon, wherein the hinge is formed or arranged at one of the sides of the polygon, and the perforation runs along the sides of the polygon. The perforation is thus formed by in each case rectilinearly extending portions. For example, the pressure-release flap is of rectangular form.

An alternative refinement provides for the pressure-release flap to have a curved delimiting line, for example to be of circular form. In this case, the perforation likewise runs in a curved manner. For example, the perforation likewise runs in a circular manner, or at least along a circular arc.

The chamber formed by the delimiting wall with the pressure-release flap may be formed in any region of the aircraft engine. One design variant provides for the delimiting wall to form an outer surface of the chamber of the aircraft engine. For example, the delimiting wall that forms the pressure-release flap forms the outer wall of an engine nacelle.

According to a further aspect of the invention, the present invention relates to an engine nacelle having a pressure-release device according to Claim 1, wherein the chamber is formed in the engine nacelle and the delimiting wall in which the pressure-release flap is formed forms an outer surface of the engine nacelle.

The invention will be explained in more detail below on the basis of a plurality of exemplary embodiments with reference to the figures of the drawing. In the drawing:

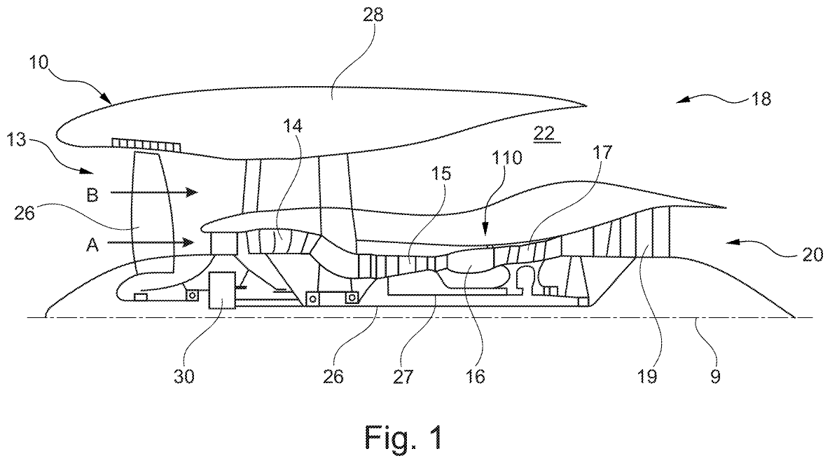

FIG. 1 shows a sectional side view of a gas turbine engine in which the present invention can be realized;

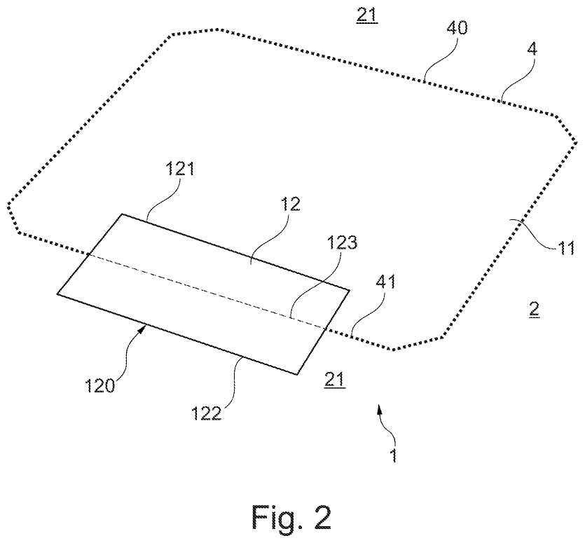

FIG. 2 shows a schematic perspective view of a pressure-release flap which is formed by means of a perforation in a delimiting wall of a chamber and which comprises a flap region and a hinge;

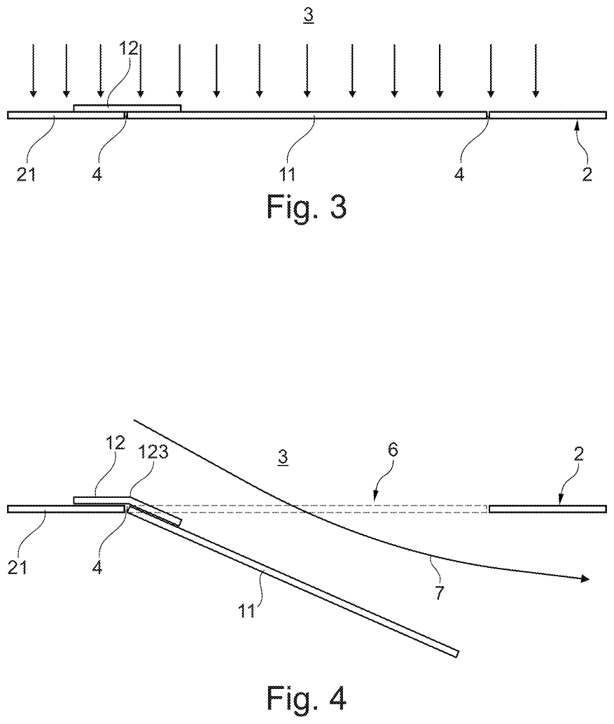

FIG. 3 shows a sectional illustration of the pressure-release flap of FIG. 2, wherein the pressure-release flap is illustrated in the closed state;

FIG. 4 shows a sectional illustration of the pressure-release flap of FIG. 2, wherein the pressure-release flap is illustrated in the open state; and

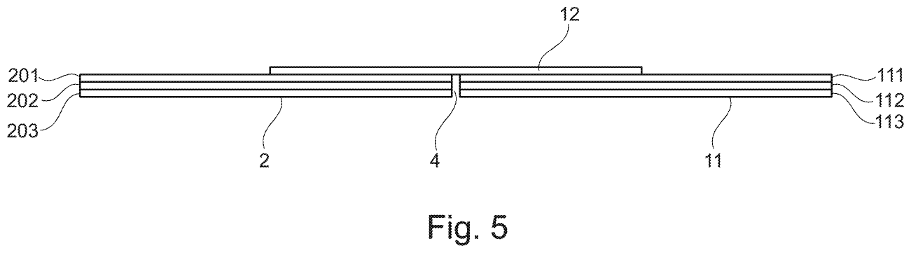

FIG. 5 shows an exemplary embodiment of a delimiting wall and of a flap region which have multiple material layers.

FIG. 1 illustrates a gas turbine engine 10 having a main axis of rotation 9. The engine 10 comprises an air intake 13 and a thrust fan 23 that generates two air flows: a core air flow A and a bypass air flow B. The gas turbine engine 10 comprises a core 110 which receives the core air flow A. In the sequence of axial flow, the engine core 110 comprises a low-pressure compressor 14, a high-pressure compressor 15, a combustion device 16, a high-pressure turbine 17, a low-pressure turbine 19, and a core thrust nozzle 20. An engine nacelle 28 surrounds the gas turbine engine 10 and defines a bypass duct 22 and a bypass thrust nozzle 18. The bypass air flow B flows through the bypass duct 22. The fan 23 is attached to and driven by the low pressure turbine 19 by way of a shaft 26 and an epicyclic gear box 30.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before they are expelled through the nozzle 20 to provide a certain thrust. The high-pressure turbine 17 drives the high-pressure compressor 15 by means of a suitable connecting shaft 27. The fan 23 generally provides the major part of the thrust force. The epicyclic gear box 30 is a reduction gear box.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

Other gas turbine engines in which the present disclosure can be used may have alternative configurations. For example, such engines may have an alternative number of compressors and/or turbines and/or an alternative number of connecting shafts. By way of a further example, the gas turbine engine shown in FIG. 1 has a split flow nozzle 20, 22, meaning that the flow through the bypass duct 22 has its own nozzle that is separate from and radially outside the core engine nozzle 20. However, this is not restrictive, and any aspect of the present disclosure can also apply to engines in which the flow through the bypass duct 22 and the flow through the core 110 are mixed or combined before (or upstream of) a single nozzle, which may be referred to as a mixed flow nozzle. One or both nozzles (whether mixed or split flow) can have a fixed or variable area. Although the example described relates to a turbofan engine, the disclosure can be applied, for example, to any type of gas turbine engine, such as, for example, an open rotor engine (in which the fan stage is not surrounded by an engine nacelle) or a turboprop engine. In some arrangements, the gas turbine engine 10 may not comprise a gear box 30.

The geometry of the gas turbine engine 10, and components thereof, is/are defined by a conventional axis system, comprising an axial direction (which is aligned with the rotation axis 9), a radial direction (in the bottom-to-top direction in FIG. 1), and a circumferential direction (perpendicular to the view in FIG. 1). The axial, radial and circumferential directions run so as to be mutually perpendicular.

What is of importance in the context of the present invention is the configuration of pressure-release flaps which delimit chambers or compartments, which are charged with a pressure, in the gas turbine engine, wherein the pressure-release flaps automatically open in the event of a defined limit pressure being exceeded. Such chambers may be formed in the interior and/or at the outer side of the gas turbine engine. They are for example adjacent to the outer skin of the engine nacelle 21 and, here, form a partial region of said outer skin. Alternatively, they are formed for example in chambers which extend between the core engine 11 and the bypass duct 22.

FIGS. 2-4 show, in a perspective view and in sectional illustrations, an exemplary embodiment of a pressure-release device which comprises a pressure-release flap 1. The pressure-release flap 1 comprises a flap region 11 and a hinge 12.

The flap region 11 is defined by a perforation 4 which is formed in a delimiting wall 2. The delimiting wall 2 delimits a chamber 3 which is pressurized, wherein it is the intention for the pressure not to exceed a defined limit pressure, cf. FIGS. 3 and 4. The chamber 3 comprises further delimiting walls, which are however not illustrated. By means of the perforation 4, the delimiting wall 2 is divided into the flap region 11 and a surrounding region 21, which surrounds the flap region 11.

The perforation 4 is formed by a multiplicity of holes 40 arranged in a line. Said holes have the same size and the same spacing to one another. Alternatively, size and/or spacing may vary. The size of the holes 40 lies for example in the range between 50 μm and 2 mm. In the exemplary embodiment illustrated, the pressure-release flap 1 is of approximately rectangular form, though this is not imperative. The perforation 4 is accordingly formed by in each case rectilinear portions, which together form a rectangle or generally a polygon.

The delimiting wall 2 including the flap region 11 is composed for example of a carbon-fiber-reinforced plastic or a glass-fiber-reinforced plastic.

The hinge 12 is fixedly connected both to the flap region 11 and to the surrounding region 21. Said hinge is formed by an areal material strip 120 which is composed of an aramid-fiber-reinforced composite material. The areal material strip 120 has two longitudinal edges 121, 122. Along one longitudinal edge 121 thereof and adjacent thereto, the material strip 120 is fixedly connected to the flap region 11. Along the other longitudinal edge 122 thereof and adjacent thereto, the material strip 120 is fixedly connected to the surrounding region 21. At the same time, it is the case that the flap region 11 and the surrounding region 21 run rectilinearly, and are rectilinearly adjacent to one another at the end sides, in the region that is covered by the hinge 12. The delimiting line 41 between the flap region 11 and the surrounding region 21 thus also defines the pivot axis 123 of the hinge 12, cf. FIG. 2.

As can be seen from FIGS. 3 and 4, the perforation 4 also runs in that region of the delimiting wall 2 in which the hinge 12 is arranged. Here, the perforation 4 is covered in this region by the material strip 120.

The connection between the hinge 12, on the one hand, and the flap region 11 and the surrounding region 21, on the other hand, may be realized for example by means of adhesive materials. Here, the hinge is produced as a separate part and is subsequently connected to the flap region 11 and to the surrounding region 21. Alternatively, the hinge 12 and the delimiting wall 2 are produced jointly, wherein a common plastics matrix is used in which aramid fibers of the hinge 12 and glass fibers or carbon fibers of the delimiting wall 2 cure, such that both material plies cure jointly and thereby connect to one another. The flap region 11 and the surrounding region 21 are formed by subsequent perforation.

The device functions as follows. If the pressure in the chamber 3 reaches a predefined pressure, the perforation 4 ruptures. For this purpose, the perforation 4 is provided with openings 40 such that it ruptures in the presence of the predefined pressure. Here, the flap region 11 pivots open relative to the surrounding region 21, such that a passage opening 6 is formed in the delimiting wall 2, via which passage opening the pressurized gas 7 can be discharged from the chamber 3 into the surroundings.

In the region of the hinge 12, however, the flap region 11 remains fixedly connected to the surrounding region 21 of the delimiting wall 2 by means of the hinge 12. The flap region 11 is thus held on the surrounding region 21 by means of the hinge 12 in the event of a rupture of the perforation 4, and cannot detach from the delimiting wall 2.

An alternative refinement provides for the delimiting wall 2 including the flap region 11 to be composed of a metal or of a metal alloy. For this case, provision may furthermore be made whereby the hinge 12 is also composed of a metal or of a metal alloy, wherein the metal or the metal alloy of which the hinge 21 is composed has sufficient ductility in order to deform during a pivoting-open of the flap region 11.

A further refinement is illustrated in FIG. 5. In said refinement, the delimiting wall 2 has a multiplicity of material layers 201, 202, 203. Correspondingly, the flap region 11 also comprises multiple material layers 111, 112, 113. Here, provision is made whereby the perforation 4 extends through all of the material layers. The hinge 12 is composed of one material ply, as is likewise the case in the exemplary embodiment of FIGS. 2-4. Alternatively, the hinge 12 may likewise be composed of a multiplicity of material plies, both in the exemplary embodiment of FIG. 5 and in the exemplary embodiment of FIGS. 2-4.

It will be understood that the invention is not limited to the embodiments described above, and various modifications and improvements can be made without departing from the concepts described herein. Furthermore, except where mutually exclusive, any of the features may be used separately or in combination with any other features, and the disclosure extends to and includes all combinations and sub-combinations of one or more features that are described herein. If ranges are defined, said ranges thus comprise all of the values within said ranges as well as all of the partial ranges that lie in a range.

1. A pressure-release device having a pressure-release flap which is arranged in a delimiting wall of a chamber of an aircraft engine and which is designed to open in the presence of a predefined pressure in the chamber,
wherein
the pressure-release flap comprises a flap region and a hinge, wherein
the flap region is defined by a perforation which is formed in the delimiting wall and which delimits the flap region with respect to a surrounding region of the delimiting wall,
the perforation is formed such that, in the presence of the predefined pressure in the chamber, the flap region pivots open relative to the surrounding region of the delimiting wall, with the perforation rupturing, and
the hinge is fixedly connected to the surrounding region of the delimiting wall and the flap region, such that the hinge holds the flap region on the surrounding region of the delimiting wall in the event of a rupture of the perforation and a pivoting-open of the flap region.

2. The device according to claim 1, wherein the perforation comprises a multiplicity of holes which are arranged in a line and which extend all the way through the delimiting wall.

3. The device according to claim 2, wherein the holes of the perforation have the same size and the same spacing to one another.

4. The device according to claim 2, wherein the holes of the perforation have a diameter which lies in the range between 50 μm and 2 mm.

5. The device according to claim 1, wherein the delimiting wall comprises multiple material layers, wherein the perforation extends through all of the material layers.

6. The device according to claim 1, wherein the hinge is composed of a different material than the delimiting wall.

7. The device according to claim 1, wherein the hinge has at least one material ply which is of areal form and which is connected on the one hand to the flap region and on the other hand to the surrounding region.

8. The device according to claim 7, wherein the material ply is in the form of an elongate material strip, wherein the material strip is connected, along one longitudinal edge thereof and adjacent thereto, to the flap region and, along the other longitudinal edge thereof and adjacent thereto, to the surrounding region, and wherein the flap region and the surrounding region are rectilinearly adjacent to one another in the portion that is covered by the elongate material strip.

9. The device according to claim 7, wherein the hinge has at least one material ply composed of a composite material.

10. The device according to claim 9, wherein the hinge has a material ply composed of an aramid-fiber-reinforced composite material.

11. The device according to claim 1, wherein the delimiting wall including the flap region is formed by a carbon-fiber-reinforced plastic or a glass-fiber-reinforced plastic.

12. The device according to claim 9, wherein the at least one material ply composed of a composite material and the delimiting wall have been cured simultaneously in a plastics matrix.

13. The device according to claim 9, wherein the at least one material ply composed of a composite material has been retroactively connected to the flap region and to the surrounding region of the delimiting wall.

14. The device according to claim 1, wherein the delimiting wall including the flap region is formed by a metal or a metal alloy.

15. The device according to claim 1, wherein the perforation also extends in that region of the delimiting wall in which the hinge is connected to the surrounding region of the delimiting wall and to the flap region, wherein the perforation is covered in this region by the hinge.

16. The device according to claim 1, wherein the hinge is formed on the inner side of the delimiting wall.

17. The device according to claim 1, wherein the pressure-release flap has the shape of a polygon, wherein the hinge is formed or arranged at one of the sides of the polygon, and the perforation runs along the sides of the polygon.

18. The device according to claim 1, wherein the pressure-release flap has a curved delimiting line, wherein the perforation runs in a curved manner.

19. The device according to claim 1, wherein the delimiting wall forms an outer surface of the chamber of the aircraft engine.

20. An engine nacelle having a pressure-release device according to claim 1, wherein the chamber is formed in the engine nacelle and the delimiting wall in which the pressure-release flap is formed forms an outer surface of the engine nacelle.
